(19) United States
(12) Patent Application Publication
(10) Pub. No.: US 2014/0183995 A1
(43) Pub. Date: Jul. 3, 2014

(54) Vibration-Proof Structure For Electric Circuit Of Electric Compressor

(71) Applicants: Atsushi Saitou, Isesaki-shi (JP); Kei Kurosaki, Isesaki-shi (JP); Kazumi Osato, Isesaki-shi (JP); Toshimasa Shima, Isesaki-shi (JP); Masafumi Karakama, Isesaki-shi (JP); Jyun Mizuno, Isesaki-shi (JP); Naritsugu Nakajima, Isesaki-shi (JP)

(72) Inventors: Atsushi Saitou, Isesaki-shi (JP); Kei Kurosaki, Isesaki-shi (JP); Kazumi Osato, Isesaki-shi (JP); Toshimasa Shima, Isesaki-shi (JP); Masafumi Karakama, Isesaki-shi (JP); Jyun Mizuno, Isesaki-shi (JP); Naritsugu Nakajima, Isesaki-shi (JP)

(73) Assignee: Sanden Corporation, Isesaki-shi Gunma (JP)

(21) Appl. No.: 14/237,816

(22) PCT Filed: Aug. 2, 2012
(86) PCT No.: PCT/JP2012/069651

§ 371 Date: Feb. 7, 2014

(30) Foreign Application Priority Data
Aug. 8, 2011 (JP) 2011-173355

(51) Int. Cl. H02K 11/00

(52) U.S. Cl. CPC H02K 11/0005
USPC 310/72

(57) ABSTRACT

A vibration-proof structure for an electric circuit for use in an inverter-integrated electric compressor can reduce cost and weight of the compressor and can have excellent productivity. The vibration-proof structure for the electric circuit of the electric compressor for use in a vehicle air conditioner, the compressor integrally including a motor for driving a compression mechanism and an electric circuit which controls drive of the motor, the structure being characterized in that an assembly 26, which is obtained by mounting at least one electric component requiring a vibration-resistant reinforcement (a coil and a capacitor constituting a noise filter, and a smoothing capacitor) on a dedicated circuit board 24 and by embedding the electric component with resin 25, is assembled in a housing of the compressor. Thus, resin consumption can be greatly reduced, cost and weight of the compressor can be reduced, and productivity can be improved.

### TECHNICAL FIELD

The present invention relates to a vibration-proof structure for an electric circuit of an electric compressor for use in a vehicle air conditioner, the compressor integrally including a motor for driving a compression mechanism and an electric circuit that controls drive of the motor.

### BACKGROUND ART

In an electric compressor for use in a vehicle air conditioner, a direct current supplied from a battery is converted to an alternating current by an inverter and feeding of a current to a motor for driving a compression mechanism is controlled. An electric compressor accommodating a circuit board, in which an electric circuit including the inverter is integrated, in a compressor housing, is known.

In such an inverter-integrated electric compressor, for an electric power supplied from an external power supply, electronic components, such as a noise filter that reduces noise and a smoothing capacitor that smooths an electric power supplied to the inverter, are provided. These electronic components may be likely to be affected by vibrations since the electronic components are, for example, large, heavy, and tall in height from a mounting surface of the circuit board.

Thus, conventionally, a vibration-resisting property is provided by filling an accommodation space of a compressor housing, in which an electric circuit is assembled, with resin (gel), to embed each of the components of the electric circuit with the resin, as disclosed in Patent Document 1.

### CITATION LIST

### Patent Document

Patent Document 1: Japanese Laid-open Patent Application Publication No. 2006-316754

### SUMMARY OF THE INVENTION

### Problems to be Solved by the Invention

However, conventionally, as in the Patent Document 1, since the electric circuit accommodation space of the compressor housing is filled with the resin until all of the electric components mounted on the printed circuit board are buried, to embed the components, a large volume of the resin to be used may be required, and accordingly, cost may increase, and weight of the compressor may also increase.

Furthermore, when the resin is cured by means of heat, it is necessary to heat the entire electric compressor (or the entire inverter unit) for a long time by using a large furnace, resulting in decreased productivity.

The present invention has been achieved in view of such conventional problems, and an object of the present invention is to provide a vibration-proof structure for an electric circuit of an electric compressor, which structure can reduce consumption of resin required to embed components, reduce cost, and reduce weight of the compressor, and provide excellent productivity.

### Means for Solving the Problems

In order to solve the above-mentioned problems, according to an aspect of the present invention, a vibration-proof structure for an electric circuit of an electric compressor for use in a vehicle air conditioner, the compressor integrally including a motor for driving a compression mechanism and an electric circuit which controls drive of the motor, is characterized by including the following configuration.

That is, an assembly, which is obtained by mounting at least one electric component requiring a vibration-resistant reinforcement in the electric circuit on a dedicated circuit board and by embedding the at least one electric component with resin, is assembled in a compressor housing.

### Effect of the Invention

According to this configuration, since only the at least one electronic component requiring a vibration-resistant reinforcement is embedded with the resin, the consumption of resin can be reduced, and accordingly, the cost and the weight of the compressor can be reduced.

Furthermore, small parts, in which only the at least one electronic component requiring the vibration-resistant reinforcement is mounted on the circuit board, can be independently heated for a shorter time in a smaller furnace to cure the resin, simultaneously while assembling the compressor body, resulting in the improved productivity.

### BRIEF DESCRIPTION OF THE DRAWINGS

FIG. 1 is a view illustrating schematic appearance of an electric compressor according to an embodiment of the present invention;

FIG. 2 is an electric circuit diagram for controlling motor drive of the electric compressor;

FIG. 3 is a plan view illustrating an interior of a housing which accommodates the electric circuit according to a first embodiment;

FIG. 4 is a cross-sectional view taken along with a line A-A of FIG. 3;

FIG. 5 is a perspective view illustrating a state in which a part of the electric circuit (smoothing capacitors and noise filter) is mounted on a circuit board;

FIG. 6 is a perspective view illustrating an assembly, in which the part of the electric circuit is embedded with resin;

FIG. 7 is a plan view illustrating an interior of a housing which accommodates an electric circuit according to a second embodiment;

FIG. 8 is a cross-sectional view taken along with a line A-A of FIG. 7 in a state in which a lid member is assembled; and

FIG. 9 is a perspective view illustrating a state in which a first heat radiation sheet member is in tight contact with an assembly, in which the part of the electric circuit is embedded with resin.

### MODE FOR CARRYING OUT THE INVENTION

Hereinbelow, embodiments of the present invention will be described with reference to the accompanying drawings.

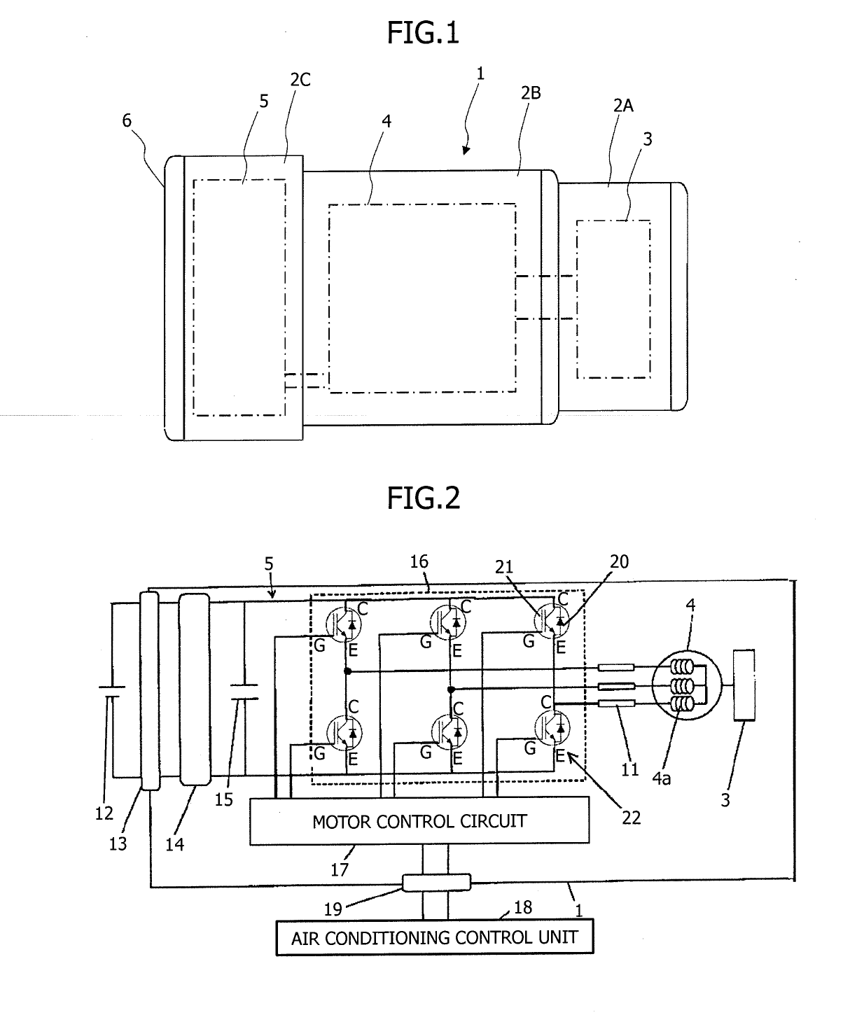

FIG. 1 illustrates schematic appearance of an electric compressor according to an embodiment of the present invention. In FIG. 1, an electric compressor 1 has housings separated in three parts, that is, housings 2A, 2B, 2C, joined to each other in series, in which a compression mechanism 3, a motor 4 that drives the compression mechanism 3, and an electric circuit 5 that controls drive of the motor 4 are accommodated, respectively. An outer opening of the housing 2C (inverter case) is closed by a lid member 6.

The electric circuit 5 includes an inverter, a smoothing capacitor that smooths an electric power supplied to the inverter, and a noise filter that reduces noise, and has a configuration as illustrated in FIG. 2, for example.

In FIG. 2, when an output from the electric circuit 5 is fed into each motor coil 4a of the motor 4 via a sealing terminal 11, the motor 4 is driven to rotate, and compression is performed by the compression mechanism 3.

To the electric circuit 5, electric power from an external power supply 12 (battery) is fed via a high-voltage connector 13. The electric power is supplied to an inverter 16 via a noise filter 14 and a smoothing capacitor 15. In the inverter 16, the direct current from the power supply 12 is converted to a pseudo three-phase alternating current, and then, the current is supplied to the motor 4.

To a motor control circuit 17, a low-voltage electric power is supplied from a vehicle air conditioning control unit 18 via a connector 19 for a control signal. The inverter 16 is provided with three pairs of, that is, six, power semiconductor devices 22, each of which includes a flywheel diode 20 and an IGBT 21.

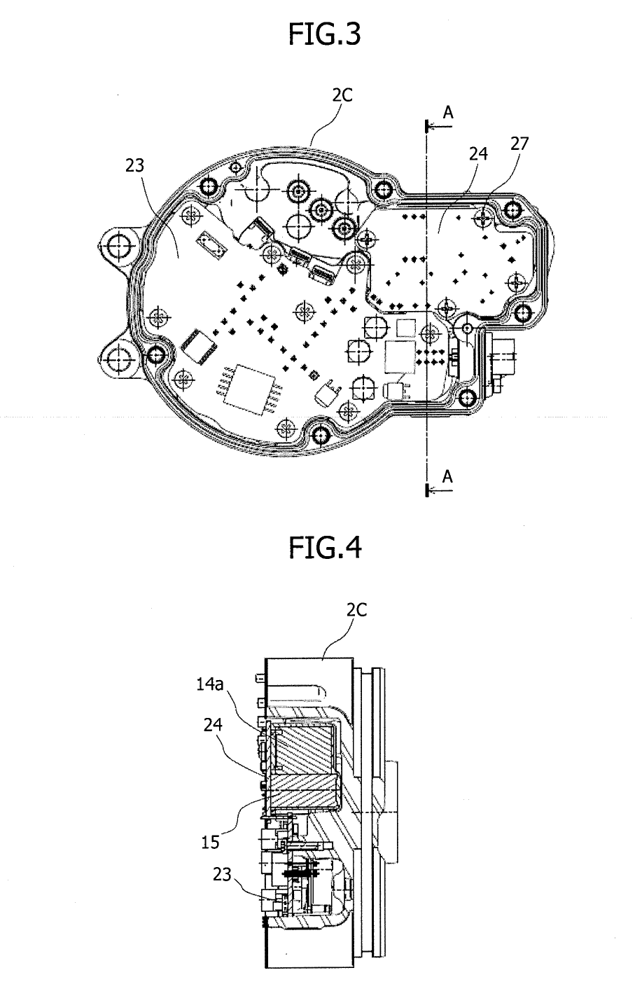

FIGS. 3 and 4 illustrate an interior of the housing 2C that accommodates the electric circuit 5. Each electric component, which constitutes the inverter 16 or the motor control circuit 17, is directly mounted on a first printed circuit board 23, or electrically connected to the first printed circuit board 23 via a lead wire.

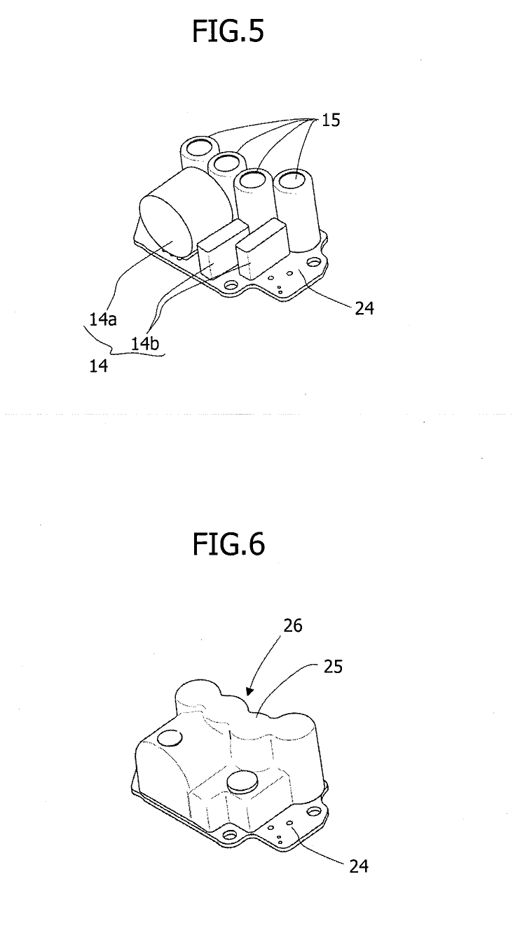

On the other hand, the smoothing capacitor 15, and a noise-reducing coil 14a and a noise-reducing capacitor 14b, that constitute the noise filter 14, (see, FIG. 5), require the vibration-resistant reinforcement, since these components are large, heavy and tall in height from a mounting surface of a circuit board as compared to each of the above-described electric components for control of the drive of motor, and accordingly, are likely to be affected by engine vibrations or vibrations of the compressor itself.

Thus, as illustrated in FIG. 5, these components which require the vibration-resistant reinforcement, that is, the smoothing capacitor 15, and the noise-reducing coil 14a and the noise-reducing capacitor 14b, that constitute the noise filter 14, are gathered and mounted on a dedicated second printed circuit board (circuit board) 24 different from the first printed circuit board 23.

Then, these electric components requiring the vibration-resistant reinforcement mounted on the second printed circuit board 24 are embedded with resin 25 to form an integrated assembly 26, as illustrated in FIG. 6. In this case, as the resin 25 used to embed the components, epoxy resin, or the like, having greater hardness than silicone gel and urethane resin, may be used.

In this case, the electric components, which are large, heavy, tall (tall in height from the mounting surface of the printed circuit board), and the like, and accordingly require the vibration-resistant reinforcement, such as the smoothing capacitor 15, and the noise-reducing coil 14a and the noise-reducing capacitor 14b, that constitute the noise filter 14, are mounted on only the mounting surface of the second printed circuit board 24 on a side facing a bottom wall of the housing 2C.

In contrast, also on an opposite mounting surface of the second printed circuit board 24, electric components, which are small and short (short in height from the mounting surface of the printed circuit board) as compared to the electric components requiring the vibration-resistant reinforcement, such as resistors, are mounted. However, these electric components are not embedded with the resin, and thus, only the electric components requiring the vibration-resistant reinforcement are embedded with the resin.

The assembly 26 embedded with the resin as described above is secured to the housing 2C with the peripheral portion of the second printed circuit board 24 fastened with a plurality of bolts 27.

According to the present embodiment, various advantageous effects as described hereunder can be achieved.

Since only the electric components requiring the vibration-resistant reinforcement are gathered and mounted on the dedicated printed circuit board 24, and then embedded with the resin, the consumption of resin can be reduced, and accordingly, the cost can be reduced, and moreover, the weight of the compressor can be reduced.

Furthermore, since the resin embedding which is cured when the resin is heated is employed, small parts can be independently heated for a shorter time using a smaller heating furnace, simultaneously while assembling the compressor body, and accordingly, the productivity can be improved.

Still further, in addition to these principal effects of the present invention, the present embodiment can achieve additional advantageous effects, that is, by gathering and mounting the electric components, which are large, heavy, tall, and the like, and require the vibration-resistant reinforcement, on the second printed circuit board 24 on the same side of the mounting surface, and further by gathering and mounting the electric components, which are small and short, such as resistor, or the like, on the printed circuit board 24 on the opposite side of the mounting surface, the electric components can be accommodated as compactly as possible, to promote a decrease in size of the compressor. Furthermore, since it is necessary to embed only the electric components requiring the vibration-resistant reinforcement with the resin on only one side of the printed circuit board, the consumption of resin can be suppressed to the minimum necessary.

Moreover, since the resin having the greater hardness, such as epoxy resin, is used to embed the components, rigidity of the printed circuit board 24 can be enhanced and the printed circuit board 24 can be prevented from being bent, for example, and thus, the number of the fastened points of the housing 2C with the bolts 27 can be decreased, resulting in improved flexibility in installation (arrangement and the number of parts) of the electric components mounted on the printed circuit board 24.

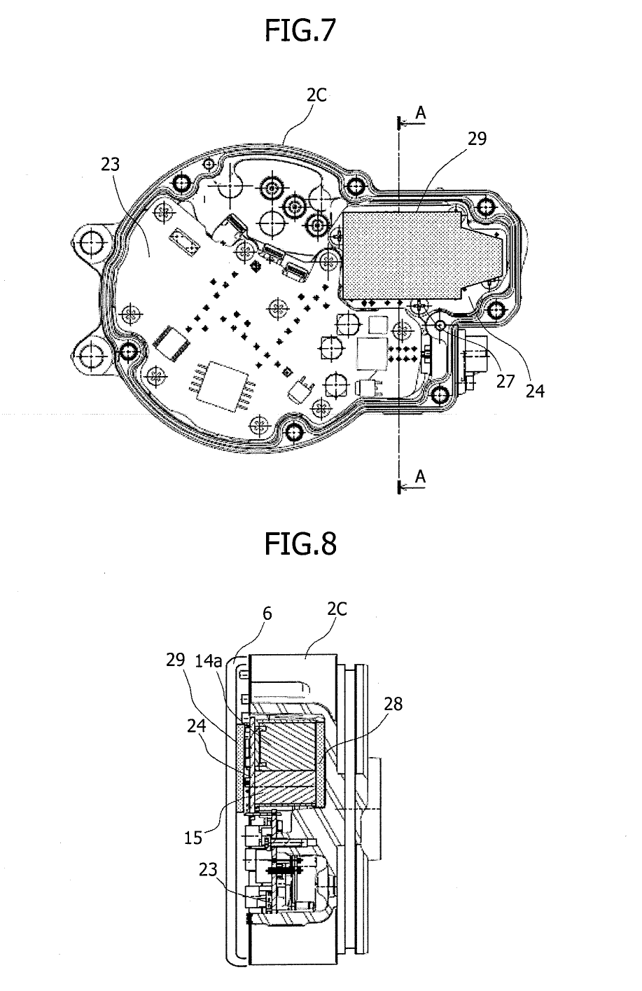

FIGS. 7 to 9 illustrate a second embodiment. According to the second embodiment, a configuration for improving a heat-radiating property is added to the configuration of the first embodiment.

That is, between an outer wall of the resin-embedded portion of the assembly 26, formed similarly as the first embodiment, and the bottom wall (inner wall) of the housing 2C facing the outer wall, a first heat radiation sheet member 28, that is made of resin or gel and has flexibility, may be disposed in a manner to be in tight contact therewith.

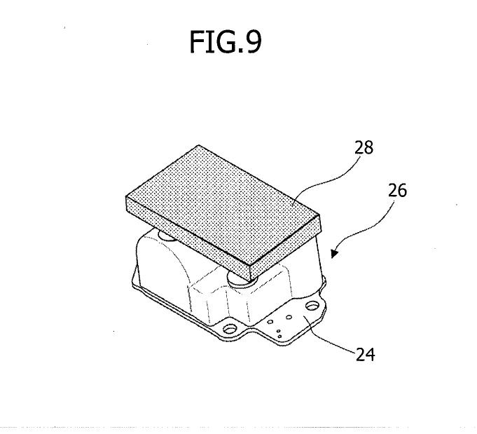

In this case, as illustrated in FIG. 9, the first heat radiation sheet member 28 may be disposed in a manner that the assembly 26, to which the first heat radiation sheet member 28 has been tightly attached, is vertically inverted and assembled on the housing 2C, so that the first heat radiation sheet member 28 is brought into tight contact with the bottom wall of the housing 2C, or alternatively, the first heat radiation sheet member 28 may be tightly attached on the bottom wall of the housing 2C in advance, and then the first heat radiation sheet member 28 may be brought into tight contact with the assembly 26 upon assembling the assembly 26 to the housing 2C.

In addition, between an outer surface of the assembly 26, on which the electric components which are small and short and which does not require the vibration-resistant reinforcement, such as a resistor, are mounted, and the lid member which covers the outer surface, a second heat radiation sheet member 29, that is made of resin or gel and has flexibility, may be disposed in a manner to be in tight contact therewith.

The first heat radiation sheet member 28 and the second heat radiation sheet member 29 may be made of the same material, such as, silicone resin or silicone gel, for example. In particular, since the outside of the second printed circuit board 24 is not embedded with the resin, the second heat radiation sheet member 29 also requires an electric insulating property.

According to the second embodiment, in addition to the above-described advantageous effects of the first embodiment, the following effects can be achieved.

Heat generated in the electric components in the assembly 26, and heat generated in other electric components disposed in the housing 2C and transferred to the assembly 26 can be released from the housing 2C and the lid member 6 via the first heat radiation sheet member 28 and the second heat radiation sheet member 29, resulting in the improved heat-radiating property and improved long-term durability of the electric circuit.

Furthermore, since the first heat radiation sheet member 28 and the second heat radiation sheet member 29, which have flexibility and low hardness, are disposed in the gaps between the assembly 26, and the housing 2C and the lid member 6, respectively, the vibration-resisting property, and ultimately, the long-term durability, can be improved.

In this case, according to the second embodiment, since both the first heat radiation sheet member 28 and the second heat radiation sheet member 29 are provided, the heat-radiating property and the vibration-resisting property can be improved. However, an alternative configuration, in which only one of the first heat radiation sheet member 28 and the second heat radiation sheet member 29 is provided, may be employed. This configuration can also achieve sufficient advantageous effects.

Furthermore, in the above embodiments, as the electric components requiring the vibration-resistant reinforcement and embedded with the resin, the large, heavy and tall smoothing capacitor and noise filter are described as examples. However, such electric components are not limited thereto. Components with a narrow terminal, or the like, that is, components likely to vibrate, may be embedded with the resin.

### REFERENCE SIGNS LIST

1 Electric compressor
2C Housing
3 Compression mechanism
4 Motor
5 Electric circuit
12 External power supply (Battery)
14 Noise filter
14a Noise-reducing coil
14b Noise-reducing capacitor
15 Smoothing capacitor
16 Inverter
17 Motor control circuit
24 Second printed circuit board
25 Resin used in embedding
26 Assembly
27 Bolt
28 First heat radiation sheet member
29 Second heat radiation sheet member

1. A vibration-proof structure for an electric circuit of an electric compressor for use in a vehicle air conditioner, the compressor integrally comprising a motor for driving a compression mechanism and an electric circuit which controls drive of the motor,
the structure being characterized in that
an assembly, which is obtained by mounting at least one electric component requiring a vibration-resistant reinforcement in the electric circuit on a dedicated circuit board and by embedding the at least one electric component with resin, is assembled in a compressor housing.

2. The vibration-proof structure for the electric circuit of the electric compressor, according to claim 1, wherein between an outer wall of the assembly and an inner wall of the compressor housing facing the outer wall, a heat radiation sheet member, which is made of resin or gel and has flexibility, is disposed in a manner to be in tight contact therewith.

3. The vibration-proof structure for the electric circuit of the electric compressor, according to claim 2, wherein the heat radiation sheet member is made of silicone resin or silicone gel.

4. The vibration-proof structure for the electric circuit of the electric compressor, according to claim 1, wherein the at least one electric component requiring the vibration-resistant reinforcement is mounted on one of mounting surfaces of the circuit board, while at least one electric component, which is short in height from a mounting surface of the circuit board as compared to the at least one electric component requiring the reinforcement, is mounted on the other mounting surface.

5. The vibration-proof structure for the electric circuit of the electric compressor, according to claim 4, wherein only the at least one electric component requiring the vibration-resistant reinforcement is embedded with the resin, and wherein between an outer wall of an embedded portion and an outer wall of the circuit board on the other mounting surface side, and inner walls of the compressor housing facing the outer walls, respectively, heat radiation sheet members, which are made of resin or gel and have flexibility, are disposed in a manner to be in tight contact therewith.

6. The vibration-proof structure for the electric circuit of the electric compressor, according to claim 5, wherein the heat radiation sheet members are made of silicone resin or silicone gel.

7. The vibration-proof structure for the electric circuit of the electric compressor, according to claim 1, wherein the resin used in embedding is epoxy resin.

8. The vibration-proof structure for the electric circuit of the electric compressor, according to claim 1, wherein the at least one electric component requiring the vibration-resistant reinforcement is a noise filter and a smoothing capacitor.
